(19) United States
(12) Patent Application Publication
(10) Pub. No.: US 2025/0076031 A1
(43) Pub. Date: Mar. 6, 2025

(54) DEVICE, SYSTEM, AND METHOD FOR IN-SITU MEASUREMENT OF THREE-DIMENSIONAL MORPHOLOGY OF MELT POOLS

(71) Applicant: WUHAN UNIVERSITY, Hubei (CN)

(72) Inventors: Hui LI, Hubei (CN); Xiuhua LI, Hubei (CN); Zhe LIU, Hubei (CN); Shengnan SHEN, Hubei (CN)

(73) Assignee: WUHAN UNIVERSITY, Hubei (CN)

(21) Appl. No.: 18/822,459

(22) Filed: Sep. 2, 2024

(30) Foreign Application Priority Data
Sep. 4, 2023 (CN) 202311141523.3

(51) Int. Cl. G01B 11/24; B22F 12/90; B23K 26/03; B23K 26/342; B33Y 10/00; B33Y 30/00; B33Y 50/00; G01B 9/02001

(52) U.S. Cl. CPC G01B 11/2441; B22F 12/90; B23K 26/032; B23K 26/342; B33Y 10/00; B33Y 30/00; B33Y 50/00; G01B 9/02001

(57) ABSTRACT

The disclosure aligns a processing laser beam and a measurement laser beam coaxially, and directs the processing laser beam and the measurement laser beam respectively onto the metal powder and melt pool surface for manufacturing and measuring the 3D of melt pool. A light beam is formed by the reference laser beam interfered with the measurement laser beam reflected by the melt pool, and is directed to the image acquisition unit to obtain an interference image of the melt pool surface. The contour accuracy was proved to be 15 nm under case of lateral resolution of 15.63 μm by the resolution board. The experiment of 3D melt pool was performed. This disclosure enables in-situ measurement of the 3D morphology of the melt pool during additive manufacturing. The disclosure is to incorporate a filter to eliminate high-temperature thermal radiation emitted from the melt pool, significantly enhancing the accuracy of morphology measurements.

### CROSS-REFERENCE TO RELATED APPLICATION

This application claims the priority benefit of China application serial no. 202311141523.3, filed on Sep. 4, 2023. The entirety of the above-mentioned patent application is hereby incorporated by reference herein and made a part of this specification.

### TECHNICAL FIELD

The present disclosure belongs to the field of three-dimensional (3D) morphology measurement technology, particularly relates to a device, system, and method for in-situ measurement of 3D morphology of melt pools.

### BACKGROUND

AM technology, as an innovative manufacturing method, has demonstrated broad application prospects in fields such as aerospace, nuclear energy, and biomedical due to advantages such as short production cycles, high complexity in forming, the capability of achieving near-net-shape parts, and excellent product performance. Laser Powder Bed Fusion (LPBF) is a mainstream metal AM technology, where key process variables during manufacturing can characterize the quality of parts. In other words, the behavior of these variables during the manufacturing process directly correlates with part performance, such as melt pool morphology, temperature, spattering, and surface morphology features.

However, LPBF is a manufacturing process involving multiscale and complex dynamics, comprising the melting, vaporization, and solidification of metal powder particles, which may lead to defects such as balling, cracking, and warping. The lack of quality assurance and performance control is a key obstacle hindering the widespread application of LPBF technology. Accordingly, research into online monitoring techniques for the LPBF AM process is essential for overcoming this challenge and is a primary focus for both academic and industrial sectors.

Nevertheless, in-situ monitoring melt pools poses significant challenges during the AM process due to the high temperatures and small area of the melt pools. Currently, high-speed cameras are often configured to capture two-dimensional surface morphology information of melt pools, but this information does not quantitatively interpret the true 3D morphology of the melt pools. Moreover, melt pools in AM processes are typically associated with high temperatures and exposure, making it difficult to capture clear surface details using high-speed cameras directly.

### SUMMARY

To address the challenges of in-situ online monitoring of the melt pool and the poor accuracy of morphology measurement, the present disclosure provides an in-situ measurement device, system, and method for in-situ 3D morphology of melt pools.

In order to solve the above-mentioned technical problems, the present disclosure provides an in-situ measurement device for in-situ 3D morphology of melt pools, comprising following aspect:

First aspect: the present disclosure provides a melt pool 3D morphology in-situ measurement device, comprising a measurement laser device, a beam splitter, a processing laser device, a galvanometer, a field lens, and an image acquisition unit.

The measurement laser device emits a measurement laser beam, the measurement laser beam is split into a first path and a second path by the beam splitter, the first path of the measurement laser beam is served as a reference laser beam, and the second path is served as the measurement laser beam. The processing laser device emits a processing laser beam, the processing laser beam is coaxial with the measurement laser beam, the processing laser beam and the measurement laser beam sequentially pass through the galvanometer and the field lens, where the processing laser beam melts the metal powder to form melt pool, the measurement laser beam is configured to measure the 3D of the melt pool, a light beam formed by the reference laser beam interfered with the measurement laser beam reflected by the melt pool is directed to the image acquisition unit, the image acquisition unit comprises a filter and a detector, the filter eliminates a high-temperature thermal radiation emitted from the melt pool, and the detector captures an interference image.

A beam expander is arranged between the measurement laser device and the beam splitter, and the expander is configured to expand the measurement laser beam emitted by the measurement laser device.

The reference laser beam reflected by a first mirror passes through the beam splitter, and interferes with the measurement laser beam reflected by the melt pool.

The in-situ measurement device for 3D morphology of melt pools further comprises a second mirror and long-pass dichroic mirror, where the measurement laser beam is reflected by the second mirror and enters the long-pass dichroic mirror, while the processing laser beam passes through the long-pass dichroic mirror and is coaxial with the measurement laser beam reflected by the long-pass dichroic mirror.

The wavelength of the measurement laser beam emitted by the measurement laser device differs from a wavelength of processing laser beam emitted by the processing laser device, but equal to the wavelength of the filter, the measurement laser device emits a continuous laser beam, and a laser scanning pitch of the processing laser device is between 50 μm and 100 μm.

The wavelength band of the selected filter is close to natural light, and allows the measurement light emissivity reflected by the melt pool surface to pass through.

Second aspect: the present disclosure provides a melt pool 3D morphology in-situ measurement system comprises an image processing unit, and the melt pool 3D morphology in-situ measurement device as claimed in claim 1, the image processing unit is configured to process the interference images to obtain the 3D morphology information of the melt pool.

The image processing unit is configured to decode the interference images to obtain 3D morphology information of the melt pool.

The 3D morphology image processing unit comprises a generative adversarial network (GAN), a wrapped phase retrieval module, and an absolute phase retrieval module. The GAN is configured to denoise the interference images. The wrapped phase retrieval module is configured to perform phase wrapping operations to obtain the wrapped phase from the interference images. The absolute phase retrieval module is configured to perform phase unwrapping operations to obtain the continuous absolute phase of the melt pool.

The accuracy of measuring the 3D morphology of the melt pool is a micrometer-level.

Third aspect: the present disclosure provides an in-situ measurement method for in-situ 3D morphology of melt pools, which is implemented using the above in-situ measurement system for in-situ 3D morphology of melt pools. The measurement method comprises the following steps:

Step 1: Obtaining interference image using the melt pool 3D morphology in-situ measurement device.

Step 2: Processing the interference images using the image processing unit to obtain 3D morphology information of the melt pool.

Specially, in step 2, during processing of the interference images, the network and module from the image processing unit which comprises a GAN, a wrapped phase retrieval module, and an absolute phase retrieval module, are invoked to perform respective processing steps. The GAN is configured to denoise the interference images. The wrapped phase retrieval module is configured to perform phase wrapping operations to obtain the wrapped phase of the interference images. The absolute phase retrieval module is configured to perform phase unwrapping operations to obtain the continuous absolute phase of the melt pool.

The disclosure provides one or more technical solutions, which have the following technical effects or advantages:

1. Addressing the current research status that can only capture two-dimensional surface morphology information of melt pools. The disclosure proposes an in-situ measurement device for in-situ 3D morphology of melt pools. This device allows the processing laser beam and the measurement laser beam to be coaxial. The two coaxial laser beams pass through mirrors and a field lens sequentially to melt the metal powder to form melt pool and measure the 3D morphology of melt pool. The measurement laser beam reflected by the melt pool and the reference laser beam interfere and enter the image acquisition unit, thereby obtaining in-situ interference images of the melt pool surface and subsequently acquiring 3D morphology information of the melt pool using the imaging processing unit. The disclosure fills the gap in in-situ online monitoring of 3D morphology of melt pools and achieves in-situ measurement and visualization of 3D morphology of melt pool during AM processes. Additionally, for melt pools often associated with high temperature and exposure during AM processes, the disclosure effectively eliminates the influence of high temperature and exposure by setting a filter to filter out high-temperature thermal radiation from the melt pool, obtaining clearer melt pool image features and effectively improving morphology measurement accuracy. The monitoring accuracy can reach micrometer-level, achieving in-situ high-precision monitoring of 3D morphology of melt pools.

2. Based on captured interference images, the disclosure processes the interference images using the image processing unit to obtain 3D morphology of the melt pool, where the unit comprises a GAN, a wrapped phase retrieval module, and an absolute phase retrieval module. The disclosure uses a GAN to process interference images, performs phase wrapping operations using a wrapped phase retrieval module to obtain the wrapped phase of interference images, and performs phase unwrapping operations using an absolute phase retrieval module to obtain the continuous absolute phase of the melt pool. Thus, the disclosure designs artificial intelligence algorithms to process interference images, not only obtaining accurate surface morphology information of melt pools in cases of rapid dynamic changes and small sizes of melt pools but also obtaining 3D morphology information of melt pools from a single interference image, providing a new approach for online monitoring in AM processes. Additionally, during processing of interference images, both network and module from the image processing unit which comprises a GAN, a wrapped phase retrieval module, and an absolute phase retrieval module, can be invoked to perform relevant processing steps, demonstrating excellent flexibility.

### BRIEF DESCRIPTION OF THE DRAWINGS

FIG. 1 shows a schematic diagram of the structural configuration of an in-situ 3D morphology measurement device for melt pools.

FIG. 2 illustrates a flowchart of artificial intelligence algorithms comprised in the image processing unit of an in-situ 3D morphology measurement system for melt pools.

FIG. 3 displays the accuracy of the in-situ 3D morphology measurement system for melt pools.

FIG. 4 is the results of the in-situ 3D morphology for melt pools.

### DETAILED DESCRIPTION

To facilitate a better understanding of the above technical solution, detailed explanations are provided with reference to the accompanying drawings and specific implementation methods.

### Embodiment 1

According to Embodiment 1 of the present disclosure, the device comprises: 1. measurement laser device, 2. beam expander, 3. beam splitter, 4, filter, 5. detector, 6. the first mirror, 7. the second mirror, 8. processing laser device, 9. long-pass dichroic mirror, 10. galvanometer, 11. field lens, and 12. image processing unit.

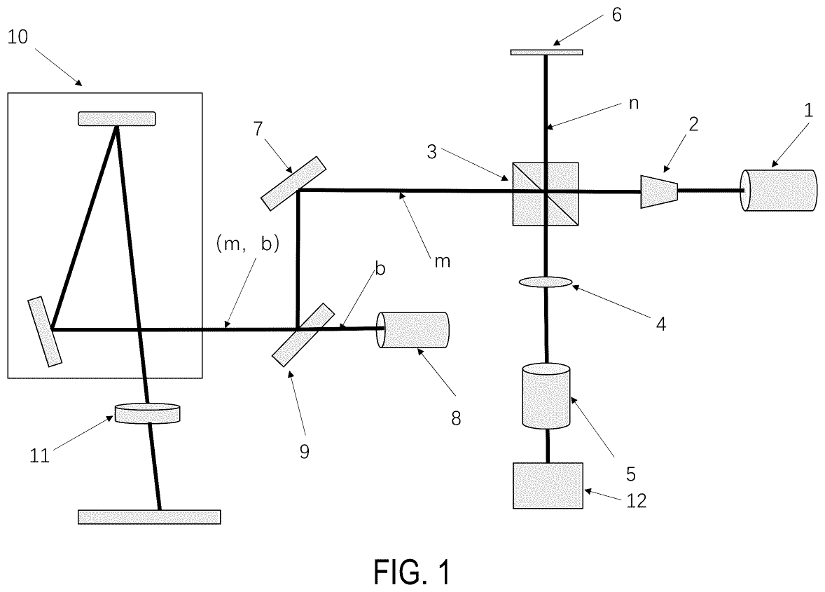

As show in FIG. 1, the measurement laser beam emitted from measurement laser device 1 is expanded by beam expander 2 and then enters beam splitter 3, the measurement laser beam is split into two paths: one path of the measurement laser beam is served as reference laser beam n and the other path of the measurement laser beam is served as measurement laser beam m.

Processing laser device 8 emits a processing laser beam b. The processing laser beam b is coaxial with the measurement laser beam m, the processing laser beam b and the measurement laser beam m sequentially pass through the galvanometer 10 and the field lens 11, the processing laser beam b melts the metal powder to form melt pool, the measurement laser beam m measures the melt pool.

Specifically, the expanded laser beam passes through beam splitter 3 to form measurement laser beam m. The measurement laser beam m reflected by a second mirror 7 is directed to the long-pass dichroic mirrors 9, the processing laser beam b passing through the long-pass dichroic mirrors 9 is coaxial with the measurement laser beam m, ensuring the in-situ capability of melt pool 3D morphology measurement. The coaxial beams (m, b) propagate to galvanometer 10, and emit out after adjusting optical path alignment of coaxial beams (m, b) by galvanometer 10. The emitted coaxial beams (m, b) focused by field lens 11 is configured to perform processing of metal powder and measurement of melt pool on the substrate.

It is noted that in Embodiment 1, long-pass dichroic mirrors 9 allows only processing laser beam b to pass through and reflects measurement laser beam m. This prevents the processing laser beam b from interfering with the interference pattern formed between the reflected measurement laser beam m from the melt pool and reference laser beam n. The selection of transmission and reflection ranges for long-pass dichroic mirrors 9 depends on the wavelength ranges of processing laser device 8 and measurement laser device 1. Long-pass dichroic mirrors 9 is specifically a long-pass beam splitter, where processing laser beam b meets the long-pass condition for transmission while measurement laser beam m, not meeting the condition, reflects back along its original path towards beam splitter 3, where it interferes with reference laser beam n.

The reflected measurement laser beam m and reference laser beam n, combined by beam splitter 3, interfere and are incident on the image acquisition unit.

Specifically, the expanded laser beam reflected by beam splitter 3 forms reference laser beam n. Reference laser beam n reflected by first mirror 6, returns through beam splitter 3, and interferes with the reflected measurement laser beam m (carrying melt pool modulation signals). After passing through beam splitter 3, reference laser beam n reflected by first mirror 6, returns along the original path, and passes through beam splitter 3, where it interferes with measurement laser beam m.

Detector 5 employs a high-speed detector to capture interference images of measurement laser beam m and reference laser beam n. Filter 4 is configured to filter out high-temperature thermal radiation from the melt pool, thereby reducing image noise captured by detector 5 due to high-temperature exposure.

To filter out high-temperature thermal radiation from the melt pool, a wavelength band selected by the filter 4 makes a radiant emittance of the melt pool surface comparable to a radiant emittance of natural light. Specifically, according to the Planck's law of black-body radiation, different wavelength conditions are calculated based on the melting temperature of the metal material to determine radiance. A curve showing radiance variation with wavelength is plotted to select a wavelength band that is close to natural light for filter 4 installation, thus minimizing the effects of high-temperature exposure and obtaining clearer melt pool image characteristics. The calculation formula for radiance corresponding to each wavelength is as follows:

$${M}_{0 \sim λ} = {\int }_{0}^{λ} \frac{{c}_{1}}{{λ}^{5} ( {e}^{{c}_{2} / λ T} - 1 )} d λ$$

where 0˜λ represents the wavelength range of emitted radiation, λ represents the wavelength, T represents temperature, and c₁, c₂ are constants.

The measurement laser device 1 emits a continuous laser beam for measuring the 3D morphology of the melt pool. To reduce interference with the processing laser beam and improve the accuracy of measuring the 3D morphology of the melt pool, the wavelength of the measurement laser beam emitted by measurement laser device 1 is different from the wavelength of the processing laser beam emitted by processing laser device 8. The processing laser beam emitted by processing laser device 8 is configured to manufacture AM parts, with a laser scanning pitch of 50 μm-100 μm and a selectable wavelength of 1064 nm.

Embodiment 1 constructs a 3D measurement device based on laser interference principles, installed in-situ such that after installation, the device can measure the 3D information of the melt pool surface at various points on the substrate without changing its installation position. The device uses a long-pass dichroic mirrors 9 to coaxially align the processing laser beam emitted by processing laser device 8 with the measurement laser beam emitted by measurement laser device 1, enabling in-situ extraction and analysis of interference patterns on the melt pool surface. By utilizing laser interference principles, the device achieves micrometer-level measurement accuracy of the melt pool surface 3D morphology, thereby obtaining high-precision 3D information of small-scale melt pools.

Thus, the in-situ measurement device for melt pool 3D morphology provided in embodiment 1 enables in-situ acquisition of interference patterns on the melt pool surface, effectively enhancing morphology measurement accuracy and achieving in-situ high-precision monitoring of melt pool 3D morphology.

### Embodiment 2

Embodiment 2 provides an in-situ measurement system for melt pool 3D morphology, comprising an image processing unit and the in-situ measurement device for melt pool 3D morphology as described in embodiment 1. The image processing unit processes the interference image to obtain the 3D morphology information of the melt pool.

The image processing unit comprises a GAN, a wrapped phase retrieval module, and an absolute phase retrieval module. The GAN is configured to denoise the interference image, the wrapped phase retrieval module is configured to perform phase wrapping to obtain the wrapped phase of the interference image, and the absolute phase retrieval module is configured to perform phase unwrapping to obtain the continuous absolute phase of the melt pool.

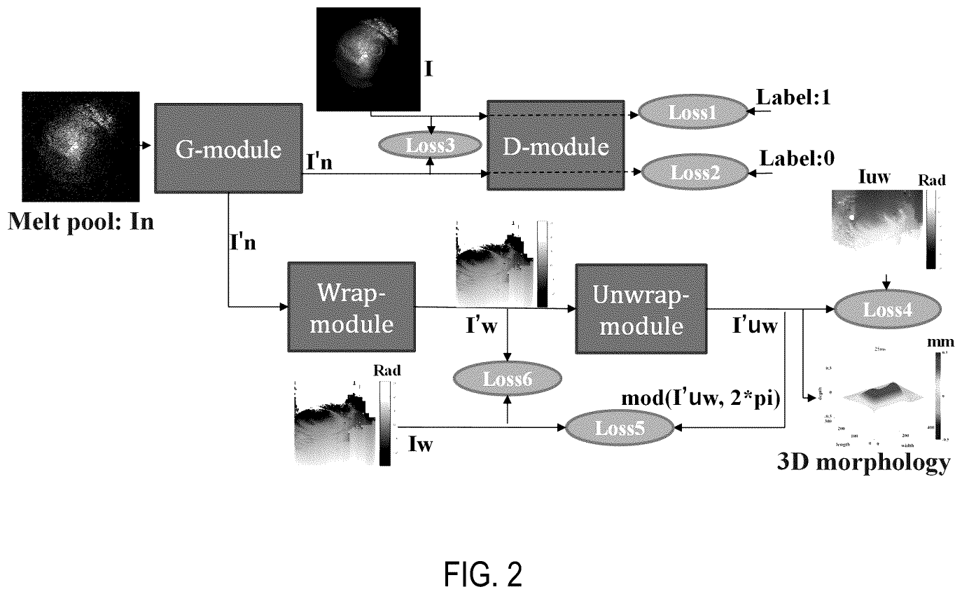

Specifically, as shown in FIG. 2, the GAN first denoises the image to optimize it. The GAN comprises a generator (G-module in FIG. 2) and a discriminator (D-module in FIG. 2). Furthermore, the wrapped phase retrieval module (Wrap-module in FIG. 2) and the absolute phase retrieval module (Unwrap-module in FIG. 2) are constructed to respectively perform phase wrapping and phase unwrapping operations. The wrapped phase retrieval module obtains the wrapped phase of the interference image, and subsequently, the absolute phase retrieval module performs phase unwrapping to obtain the continuous phase distribution of the melt pool surface. Embodiment 2 simultaneously uses multiple loss functions for backpropagation to optimize and update weights, ensuring that the image accurately reflects the 3D morphology of the melt pool.

Specifically, the disclosure constructs training and testing datasets, builds generators and discriminators, trains the generator for denoising by inputting noisy images (i.e., original interference images of melt pool) and generating denoised images (i.e., denoised interference images of melt pool). The discriminator performs real-fake classification on input images, distinguishing between denoised images and real images (i.e., noise-free interference images of melt pool). Loss values are propagated back and optimized to train the GAN and find the optimal parameters for network performance. Additionally, the disclosure constructs wrapped phase retrieval and absolute phase retrieval modules, using training and testing datasets to train and find optimal parameters for these two modules (i.e., two network models).

The flowchart of the artificial intelligence algorithm is shown in FIG. 2. G-module and D-module are configured to construct a GAN for denoising original interference images (i.e., noisy interference images of melt pool). The original interference image In passes through the G-module to output the denoised interference image I′n. The denoised interference image I′n and the noise-free interference image I are input into the D-module separately. The output of the D-module is calculated with loss values Label: 0 and Label: 1. For the G-module the loss value is Loss3+Loss2, where Loss3 is the loss value formed by the denoised interference image I′n and the noise-free interference image I. For the D-module the loss value is Loss1+Loss2. Loss1 is the loss value corresponding to Label: 1, and Loss2 is the loss value corresponding to Label: 0. The loss values are propagated back and optimized, training the GAN.

The denoised interference image I′n is input into the Wrap-module, which outputs the predicted wrapped phase I′w, and the predicted wrapped phase I′w is operated with the real wrapped phase Iw to obtain the loss value Loss6, and the loss value Loss6 is propagated back with network weight optimization.

The predicted wrapped phase I′w is input into the Unwarp-module for phase unwrapping, and the Unwarp-module outputs the predicted absolute phase I′uw. The predicted absolute phase I′uw is operated with the real absolute phase Iuw to obtain the loss value Loss4, and the predicted absolute phase I′uw is transformed into wrapped image and its phase angle is operated with the real wrapped phase Iw to obtain the loss value Loss5, finally obtaining the loss value of Unwarp-module: Loss4+Loss5, and backpropagation through the loss value for parameter optimization, training and updating Unwarp-module.

After obtaining the well-trained network model, the melt pool interference image is input into G-module, Wrap-module, and Unwarp-module respectively, and finally obtaining the continuous absolute phase of the melt pool and accurate melt pool surface morphology information according to the relationship between phase and geometric morphology.

In addition, the interference image phase analysis algorithm provided by the disclosure comprises denoising, wrapped phase retrieval, and absolute phase retrieval. The disclosure not only utilizes GAN, wrapped phase retrieval modules, and absolute phase retrieval modules to perform the above three steps respectively, but also combines traditional algorithms to separately use parts of networks or modules, such as using G-module for interference phase denoising and using Unwarp-module to obtain continuous absolute phase after obtaining wrapped phase by Warp-module.

In summary, embodiment 2 designs deep neural networks to denoise interference images and obtain wrapped phases of melt pools, and finally obtains continuous phases of melt pools through phase unwrapping, thereby obtaining precise surface morphology information of melt pools, and can obtain 3D morphology information of melt pools through a single shot (i.e., using one interference image), providing a new approach for online monitoring of AM processes.

### Embodiment 3

Embodiment 3 provides an in-situ measurement method for melt pool 3D morphology, utilizing the in-situ measurement system for melt pool 3D morphology as described in embodiment 2. The measurement method comprises the following steps:

Step 1, obtaining interference images using the in-situ measurement device for melt pool 3D morphology

Step 2, processing the interference images using the image processing unit to obtain 3D morphology information of the melt pool

In step 2, when processing the interference images, both network and module contained in the image processing unit, such as a GAN, wrapped phase retrieval module, and absolute phase retrieval module, executes relevant processing steps. The GAN is configured to denoise the interference images; the wrapped phase retrieval module is configured to perform phase wrapping to obtain the wrapped phase of the interference images; the absolute phase retrieval module is configured to perform phase unwrapping to obtain the continuous absolute phase of the melt pool.

Thus, embodiment 3 provides a method mainly comprising aligning the processing laser beam with the measurement laser beam coaxially and acting on the processing and measurement of the machining surface melt pool respectively. The measurement laser device emits a measurement laser beam that is collimated through a beam expander and split into two beams under the action of a beam splitter. One beam passing through the beam splitter is used as the measurement laser beam and reaches the melt pool after enters the galvanometer and field lens, carrying the melt pool modulation signal and returning. The other beam of light reflected by the beam splitter is used as the reference laser beam and reflects at the first reflector to returns to the beam splitter and forms interference with the melt pool morphology modulation signal at high-speed detector to obtain interference image, and then using artificial intelligence algorithm to perform interference image analysis. Continuous phase information of melt pool surface and high-precision 3D information of melt pool surface are obtained successively.

The measurement method for in-situ measurement of melt pool 3D morphology provided in embodiment 3 corresponds to the functions of various devices and units in the in-situ measurement system for melt pool 3D morphology provided in embodiment 2, and is therefore not repeated.

### Embodiment 4

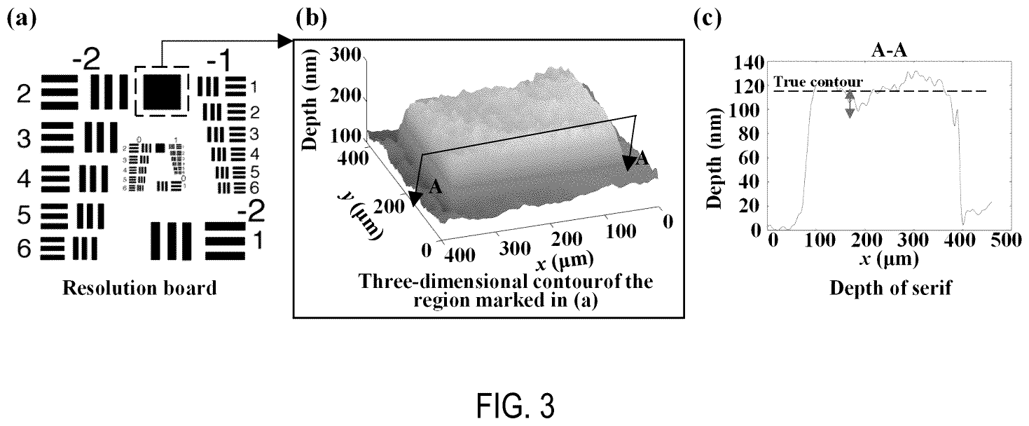

Embodiment 4 provides accuracy validation for the 3D morphology system by the standard resolution board. (a) of FIG. 3 displays the standard resolution board, and the 3D contour of region marked in (a) of FIG. 3 is denoted in (b) of FIG. 3, where the true height of the region is known as 120 nm. (c) of FIG. 3 is the depth of serif from (b) of FIG. 3. According to the Rayleigh criterion, the lateral resolution of 15.63 μm can be obtained. The contour error of 15 nm can be realized by calculating the root mean square error (RMSE) of 3D contour of the region marked in (a) of FIG. 3.

### Embodiment 5

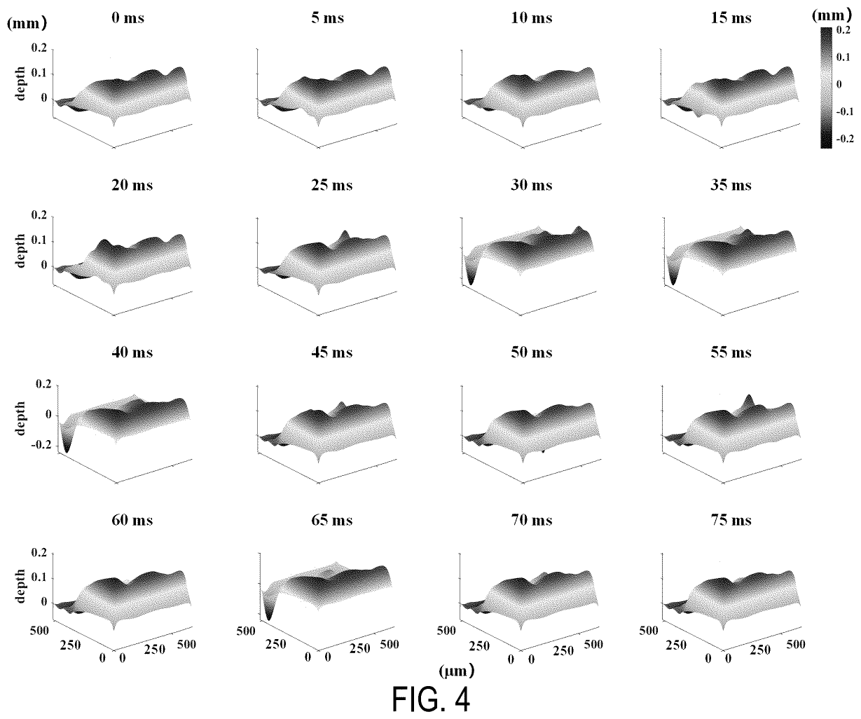

Embodiment 5 displays the 3D morphology of melt pool. As shown in FIG. 4, the interference fringe of melt pool is captured with an interval of 5 ms by the in-situ measurement device described in embodiment 1, and inputted into the image processing unit described in embodiment 2 and then into in-situ get 3D morphology of melt pool. The depth of melt pool ranges from −0.2 mm to 0.2 mm under the case of substrate as the depth plane of zeros, and lateral size is in the range of (200, 400) μm.

In conclusion, the disclosure utilizes the high precision of laser interference technology, combines the design of coaxial optical paths, and performs phase calculation of interference images using artificial intelligence algorithms, thereby improving the accuracy of measuring the 3D morphology of the melt pool, overcoming the difficulties of in-situ online monitoring of small and rapidly changing melt pools.

What is claimed is:

1. A melt pool 3D morphology in-situ measurement device, comprising a measurement laser device, a beam splitter, a processing laser device, a galvanometer, a field lens, and an image acquisition unit,
wherein the measurement laser device emits a measurement laser beam, the measurement laser beam is split into a first path and a second path by the beam splitter, the first path of the measurement laser beam is served as a reference laser beam, and the second path is served as the measurement laser beam,
wherein the processing laser device emits a processing laser beam, the processing laser beam is coaxial with the measurement laser beam, the processing laser beam and the measurement laser beam sequentially pass through the galvanometer and the field lens,
wherein the processing laser beam melts the metal powder to form melt pool, the measurement laser beam is configured to measure the 3D of the melt pool, a light beam formed by the reference laser beam interfered with the measurement laser beam reflected by the melt pool is directed to the image acquisition unit, the image acquisition unit comprises a filter and a detector, the filter eliminates a high-temperature thermal radiation emitted from the melt pool, and the detector captures an interference image.

2. The melt pool 3D morphology in-situ measurement device according to claim 1, wherein a beam expander is arranged between the measurement laser device and the beam splitter, the expander is configured to expand the measurement laser beam emitted by the measurement laser device, the reference laser beam reflected by a first mirror passes through the beam splitter, and interferes with the measurement laser beam reflected by the melt pool.

3. The melt pool 3D morphology in-situ measurement device as claimed in claim 1, further comprising second mirror and a long-pass dichroic mirror, wherein the measurement laser beam is reflected by the second mirror and enters the long-pass dichroic mirror, while the processing laser beam passes through the long-pass dichroic mirror and is coaxial with the measurement laser beam reflected by the long-pass dichroic mirror.

4. The melt pool 3D morphology in-situ measurement device as claimed in claim 1, wherein a wavelength of the measurement laser beam emitted by the measurement laser device differs from a wavelength of processing laser beam emitted by the processing laser device, but is equal to the wavelength of the filter, the measurement laser device emits a continuous laser beam, and a laser scanning pitch of the processing laser device is between 50 μm and 100 μm.

5. The melt pool 3D morphology in-situ measurement device as claimed in claim 1, wherein a wavelength band of the selected filter is close to natural light, and allows the measurement light emissivity reflected by the melt pool surface to pass through.

6. A melt pool 3D morphology in-situ measurement system, comprising an image processing unit, and the melt pool 3D morphology in-situ measurement device as claimed in claim 1, wherein the image processing unit is configured to decode the interference images to obtain 3D morphology information of the melt pool.

7. The melt pool 3D morphology in-situ measurement system as claimed in claim 6, wherein the 3D morphology image processing unit comprises a GAN, a wrapped phase retrieval module, and an absolute phase retrieval module, wherein the GAN is configured to denoise the interference images, the wrapped phase retrieval module is configured to perform phase wrapping operations to obtain the wrapped phase of the interference images, and the absolute phase retrieval module is configured to perform phase unwrapping operations to obtain the continuous absolute phase of the melt pool.

8. The melt pool 3D morphology in-situ measurement system as claimed in claim 6, wherein an accuracy of measuring the 3D morphology of the melt pool is a micrometer-level.

9. A method for in-situ measurement of 3D morphology of melt pool as claimed in claim 6, an in-situ measurement method for in-situ 3D morphology of melt pools comprises the following steps:
Step 1: obtaining interference image using the melt pool 3D morphology in-situ measurement device;
Step 2: processing the interference images using the image processing unit to obtain 3D morphology information of the melt pool.

10. A method for in-situ measurement of 3D morphology of a melt pool as claimed in claim 9, wherein in the step 2, during processing of the interference images, the network and module from the image processing unit which comprises a GAN, a wrapped phase retrieval module, and an absolute phase retrieval module, are invoked to perform respective processing steps, wherein the GAN is configured to denoise the interference images, the wrapped phase retrieval module is configured to perform phase wrapping operations to obtain the wrapped phase of the interference images, and the absolute phase retrieval module is configured to perform phase unwrapping operations to obtain the continuous absolute phase of the melt pool.
